(19) United States
(12) Patent Application Publication
(10) Pub. No.: US 2014/0050287 A1
(43) Pub. Date: Feb. 20, 2014

(54) DATA SLICER FOR REDUCING SYSTEM START-UP TIME AND RECEIVER WITH THE SAME

(71) Applicant: PRINCETON TECHNOLOGY CORPORATION, New Taipei City (TW)

(72) Inventors: Tsung-Yuan CHIANG, Banciao City (TW); Nien-An KAO, Xindian City (TW)

(73) Assignee: PRINCETON TECHNOLOGY CORPORATION, New Taipei City (TW)

(21) Appl. No.: 13/788,870

(22) Filed: Mar. 7, 2013

(30) Foreign Application Priority Data
Aug. 14, 2012 (TW) 101129308

(51) Int. Cl. H04B 1/16

(52) U.S. Cl. CPC H04B 1/16
USPC 375/343

(57) ABSTRACT

A receiver for reducing a system start-up time includes an antenna, an RF (Radio Frequency) circuit, a demodulation circuit, and a data slicer. The data slicer includes a filter, a comparator, a switch, and a delay generator. The filter filters a demodulated signal so as to generate a threshold level. The comparator has a positive input terminal for receiving the demodulated signal and a negative input terminal for receiving the threshold level. The comparator compares the demodulated signal with the threshold level so as to generate a digital signal. The switch is coupled between the positive input terminal and the negative input terminal. The delay generator determines whether or not to close the switch during a delay time according to an enable signal.

### CROSS REFERENCE TO RELATED APPLICATIONS

This Application claims priority of Taiwan Patent Application No. 101129308 filed on Aug. 14, 2012, the entirety of which is incorporated by reference herein.

### BACKGROUND OF THE INVENTION

1. Field of the Invention

The disclosure is generally related to a receiver, and more particularly to a receiver for reducing a system start-up time.

2. Description of the Related Art

In a traditional receiver, a time constant of a filter is determined according to a data rate of an RF (Radio Frequency) signal. If the data rate is low, the time constant of the filter should be large.

For a portable device or an application for saving power, a receiver enters a disable mode or a sleeping mode when the receiver is not in use. Accordingly, the system start-up time is associated with the reaction time of the device.

A large time constant of the filter leads to a long system start-up time, thereby indirectly increasing the reaction time of the device.

To solve the foregoing problem, there is a need to design a novel receiver for reducing the system start-up time.

### BRIEF SUMMARY OF THE INVENTION

In one exemplary embodiment, the disclosure is directed to a receiver for reducing a system start-up time, comprising: an antenna, receiving an RF (Radio Frequency) signal; an RF circuit, generating a mid-band signal according to the RF signal; a demodulation circuit, demodulating the mid-band signal so as to generate a demodulation signal; and a data slicer, comprising: a filter, filtering the demodulation signal so as to generate a threshold level; a comparator, having a positive input terminal for receiving the demodulation signal and a negative input terminal for receiving the threshold level, wherein the comparator compares the demodulation signal with the threshold level so as to generate a digital signal; a switch, coupled between the positive input terminal and the negative input terminal; and a delay generator, determining whether or not to close the switch during a delay time according to an enable signal.

In another embodiment, the disclosure is directed to a data slicer for reducing a system start-up time, comprising: a filter, filtering a demodulation signal so as to generate a threshold level; a comparator, having a positive input terminal for receiving the demodulation signal and a negative input terminal for receiving the threshold level, wherein the comparator compares the demodulation signal with the threshold level so as to generate a digital signal; a switch, coupled between the positive input terminal and the negative input terminal; and a delay generator, determining whether or not to close the switch during a delay time according to an enable signal.

### BRIEF DESCRIPTION OF DRAWINGS

The invention can be more fully understood by reading the subsequent detailed description and examples with references made to the accompanying drawings, wherein:

FIG. 1 is a diagram for illustrating a receiver according to an embodiment of the invention;

FIG. 2 is a diagram for illustrating voltage over time according to an embodiment of the invention; and

FIG. 3 is a diagram for illustrating a receiver according to another embodiment of the invention.

### DETAILED DESCRIPTION OF THE INVENTION

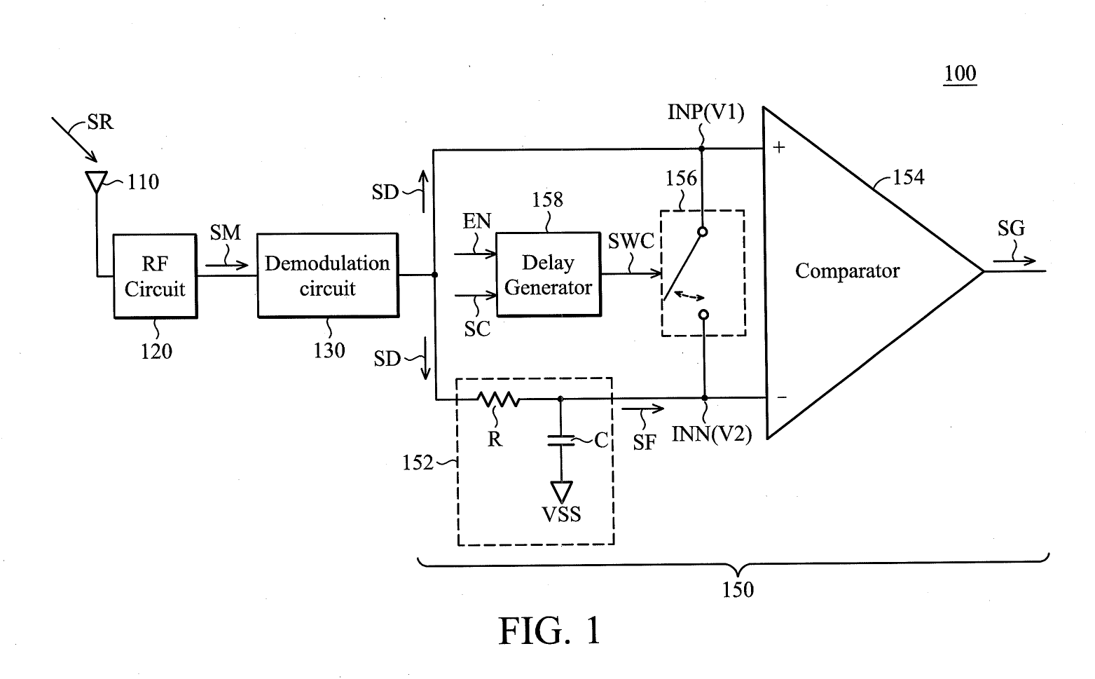

FIG. 1 is a diagram for illustrating a receiver 100 according to an embodiment of the invention. As shown in FIG. 1, the receiver 100 comprises an antenna 110, an RF (Radio Frequency) circuit 120, a demodulation circuit 130, and a data slicer 150. The antenna 110 is configured to receive an RF signal SR. The antenna 110 may be a PIFA (Planar Inverted-F Antenna), a monopole antenna, a loop antenna, a helical antenna, or a chip antenna. The RF circuit 120 may comprise a low-noise amplifier, a mixer, and a local oscillator (not shown). The RF circuit 120 generates a mid-band signal SM according to the RF signal SR. The demodulation circuit 130 demodulates the mid-band signal SM so as to generate a demodulation signal SD.

The data slicer 150 comprises a filter 152, a comparator 154, a switch 156, and a delay generator 158. The filter 152 filters the demodulation signal SD so as to generate a threshold level SF. The filter 152 may be a low-pass filter and comprises a resistor R and a capacitor C. The resistor R is coupled between the demodulation circuit 130 and a negative input terminal INN of the comparator 154. The capacitor C is coupled between the negative input terminal INN of the comparator 154 and a ground voltage VSS.

In an embodiment, the resistance of the resistor R is ranged about 10 kΩ to 200 kΩ and the capacitance of the capacitor C is ranged about 10 nF to 150 nF. However, the invention is not limited to the above. A designer can select the appropriate resistance and capacitance according to the data rate of the RF signal SR.

The comparator 154 has a positive input terminal INP for receiving the demodulation signal SD and a negative input terminal INN for receiving the threshold level SF. The comparator 154 compares the demodulation signal SD with the threshold level SF as to generate a digital signal SG. The switch 156 is coupled between the positive input terminal INP and the negative input terminal INN. The delay generator 158 determines whether or not to close (or turn on) the switch 156 during a delay time TD according to an enable signal EN after the system is enabled. In an embodiment, the delay time TD is a constant value. In another embodiment, the delay generator 158 further adjusts the delay time TD according to a control signal SC.

More particularly, when the enable signal EN is changed from the ground voltage VSS to a work voltage VDD, a delay time TD is started, and the delay generator 158 generates a switching signal SWC so as to close (or turn on) the switch 156 during the delay time TD. When the delay time TD expires, the delay generator 158 generates another switching signal SWC so as to open (or turn off) the switch 156.

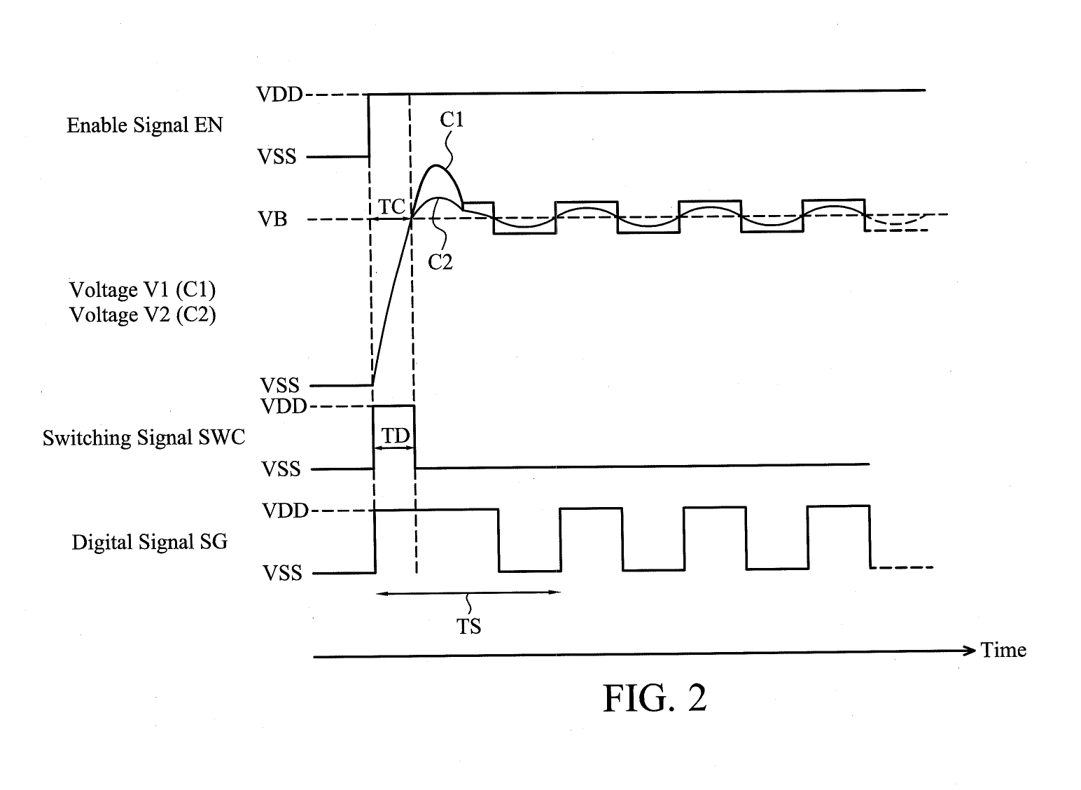

FIG. 2 is a diagram for illustrating voltage over time according to an embodiment of the invention. As shown in FIG. 2, the enable signal EN is changed from the ground voltage VSS to the work voltage VDD, and then is maintained at the work voltage VDD constantly. The switching signal SWC, generated by the delay generator 158, is changed from the ground voltage VSS to the work voltage VDD, and then is at the work voltage VDD merely for the delay time TD. When the delay time TD expires, the switching signal SWC is changed back to the ground voltage VSS. The curve C1 represents a voltage V1 over time at the positive input terminal INP of the comparator 154, and the curve C2 represents a voltage V2 over time at the negative input terminal INN of the comparator 154.

When the switch 156 is closed, the negative input terminal INN receives the demodulation signal SD and the threshold level SF. This increases the speed of charging the capacitor C such that it takes a smaller charging time TC for the voltage V2 to rise from the ground voltage VSS to a bias voltage VB. Ideally, after the delay time TD, the voltage V2 rises exactly up to the bias voltage VB. In other words, the delay time TD is exactly equal the charging time TC. A system start-up time TS of the data slicer 150 is generally defined as a first complete period of the digital signal SG. The system start-up time TS is associated with the charging time TC. If the charging time TC becomes smaller, the system start-up time TS will also become smaller.

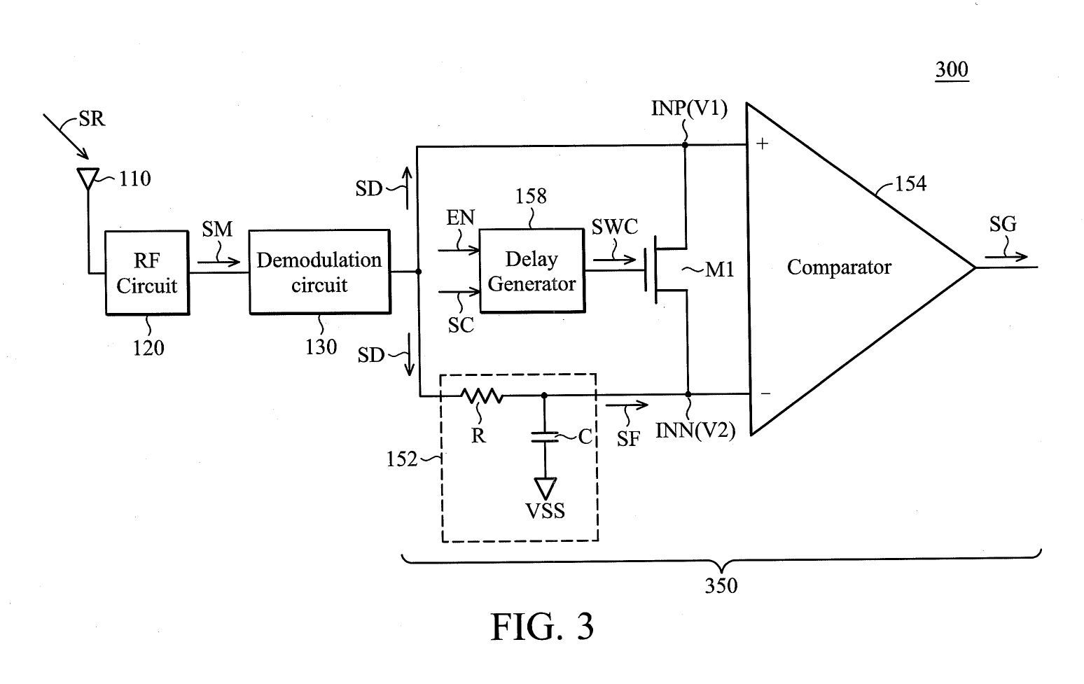

FIG. 3 is a diagram for illustrating a receiver 300 according to another embodiment of the invention. As shown in FIG. 3, a switch of a data slicer 350 of the receiver 300 is an NMOS transistor (N-channel Metal-Oxide-Semiconductor Field-Effect Transistor) M1. The NMOS transistor M1 is coupled between the positive input terminal INP and the negative input terminal INN, and has a gate coupled to the delay generator 158. The gate is arranged for receiving the switching signal SWC. Other elements and signals are similar to those in FIGS. 1 and 2, and they will be not illustrated again here. Note that the switch 156 may be also implemented with a PMOS transistor (P-channel Metal-Oxide-Semiconductor Field-Effect Transistor), a transmission gate, or other relative semiconductor elements.

In the invention, the delay generator 158 can close the switch 156 during the delay time TD in such a manner that the system start-up time TS of the data slicer 150 is decreased. The invention effectively improves the performances of the receiver and the data slicer.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and can be made in the invention. It is intended that the standard and examples be considered as exemplary only, with a true scope of the disclosed embodiments being indicated by the following claims and their equivalents.

What is claimed is:

1. A receiver for reducing a system start-up time, comprising:
an antenna, receiving an RF (Radio Frequency) signal;
an RF circuit, generating a mid-band signal according to the RF signal;
a demodulation circuit, demodulating the mid-band signal so as to generate a demodulation signal; and
a data slicer, comprising:
a filter, filtering the demodulation signal so as to generate a threshold level;
a comparator, having a positive input terminal for receiving the demodulation signal and a negative input terminal for receiving the threshold level, wherein the comparator compares the demodulation signal with the threshold level so as to generate a digital signal;
a switch, coupled between the positive input terminal and the negative input terminal; and
a delay generator, determining whether or not to close the switch during a delay time according to an enable signal.

2. The receiver as claimed in claim 1, wherein the delay generator further adjusts the delay time according to a control signal.

3. The receiver as claimed in claim 1, wherein when the enable signal is changed from a ground voltage to a work voltage, a delay time is started and the delay generator closes the switch during the delay time, and when the delay time expires, the delay generator opens the switch.

4. The receiver as claimed in claim 1, wherein the filter comprises a resistor and a capacitor, the resistor is coupled between the demodulation circuit and the input terminal, and the capacitor is coupled between the negative input terminal and a ground voltage.

5. The receiver as claimed in claim 4, wherein a resistance of the resistor is ranged about 10 kΩ to 200 kΩ.

6. The receiver as claimed in claim 4, wherein a capacitance of the capacitor is ranged about 10 nF to 150 nF.

7. The receiver as claimed in claim 1, wherein the switch is an NMOS transistor (N-channel Metal-Oxide-Semiconductor Field-Effect Transistor), and the NMOS transistor has a gate coupled to the delay generator.

8. A data slicer for reducing a system start-up time, comprising:
a filter, filtering a demodulation signal so as to generate a threshold level;
a comparator, having a positive input terminal for receiving the demodulation signal and a negative input terminal for receiving the threshold level, wherein the comparator compares the demodulation signal with the threshold level so as to generate a digital signal;
a switch, coupled between the positive input terminal and the negative input terminal; and
a delay generator, determining whether or not to close the switch during a delay time according to an enable signal.

9. The data slicer as claimed in claim 8, wherein the delay generator further adjusts the delay time according to a control signal.

10. The data slicer as claimed in claim 8, wherein when the enable signal is changed from a ground voltage to a work voltage, a delay time is started and the delay generator closes the switch during the delay time, and when the delay time expires, the delay generator opens the switch.

11. The data slicer as claimed in claim 8, wherein the filter comprises a resistor and a capacitor.

12. The data slicer as claimed in claim 11, wherein a resistance of the resistor is ranged about 10 kΩ to 200 kΩ.

13. The data slicer as claimed in claim 11, wherein a capacitance of the capacitor is ranged about 10 nF to 150 nF.

14. The data slicer as claimed in claim 8, wherein the switch is an NMOS transistor (N-channel Metal-Oxide-Semiconductor Field-Effect Transistor), and the NMOS transistor has a gate coupled to the delay generator.
